(19) United States
(12) Patent Application Publication
(10) Pub. No.: US 2018/0293303 A1
(43) Pub. Date: Oct. 11, 2018

(54) RETRIEVING SENSOR DATA BASED ON USER INTEREST

(71) Applicant: PCMS Holdings, Inc., Wilmington, DE (US)

(72) Inventor: Mona Singh, Cary, NC (US)

(21) Appl. No.: 15/570,966

(22) PCT Filed: May 13, 2016
(86) PCT No.: PCT/US2016/032456

§ 371 Date: Oct. 31, 2017

Related U.S. Application Data
(60) Provisional application No. 62/165,709, filed on May 22, 2015.

(51) Int. Cl. G06F 17/30

(52) U.S. Cl. CPC G06F 17/30684; G06F 17/30867

(57) ABSTRACT

Systems and methods are described for providing sensor data based on user interest. In an exemplary method, a subject of a user search is detected. The subject of the user search may be, for example, a particular location, such as a city or hotel, or a type of object, such as a model of car or a household appliance. When results of the search are displayed to a user, user interest in a particular phrase in the results may be detected, e.g. by detecting that the user is gazing at the phrase. In response, the system automatically identifies sensor type associated with the phrase, retrieves sensor data from sensors of the identified sensor type, and presenting the retrieved sensor data to the user.

### CROSS-REFERENCE TO RELATED APPLICATIONS

This application claims priority to and the benefit under 35 U.S.C. § 119(e) of U.S. Provisional Patent Application Ser. No. 62/165,709, filed May 22, 2015 and entitled “Retrieving Sensor Data Based on User Interest,” the full contents of which are hereby incorporated herein by reference.

### BACKGROUND

Individuals today access various kinds of information. For example, individuals may access social and news media for work, pleasure, or health, and may search for information about places and objects (such as physical or media objects). To access this information, individuals may determine what to search for by producing queries that identify salient places and objects, may execute such queries to obtain descriptions and reviews of those places and objects, and may then filter the results in order to obtain relevant information.

Current information-retrieval mechanisms are limited in that such mechanisms rely on descriptions and reviews of salient places and objects. As a result, the obtained information may be incomplete: some places and objects may not have been reviewed in sufficient quantity or with sufficient quality. The information may be biased: some places and objects may have attracted reviews on their negative aspects more so than their positive aspects (or vice versa). The information could be subjective: judgments may depend upon the person writing the review and may not match others' preferences or usage patterns—e.g., a person's preference for hot or cold may differ from the preference of the review writer, or an individual who goes to bed at 10:00 PM may hear more noise at bedtime than a person who goes to bed at 2:00 AM.

### SUMMARY

Among the embodiments described herein are various embodiments for (i) determining what information is relevant to a user based on tracking the user's interest via gaze, mouse hover, etc., (ii) obtaining, from wearable and environmental sensors, metadata related to the user's current interest, and (iii) filtering out information that is not relevant to the user based on the content of the information and metadata associated with that information (which may itself be based on obtained sensor data).

In an exemplary embodiment, a computing system receives information indicative of a user interest in an attribute of a product or service. A plurality of types of data that influence user perception of that attribute are determined. This determination may be based on semantics, a lexicon, or based on a lookup table. This determination in some embodiments may be based on a user agent (using, e.g., user specific characteristics based on a historic record of their experience). A plurality of data sources associated with the determined plurality of types of data are determined. At least one set of data is obtained from each of the plurality of data sources based upon information associated with the user interest. The set of data may be is based on data obtained within a particular distance from a location associated with the service, and/or the set may be based on data collected during a time period associated with a time period associated with the user interest (e.g., same time of year, week, night). The obtained sets of data are analyzed to produce an objective picture of the data pertinent to the attribute of the product or service of interest to the user. A data-derived objective representation of the pertinent data related to the attribute of interest is derived from the analyzed data and presented to the user. The objective representation may be based on data obtained from the plurality of data sources associated with the determined plurality of data types that affect the relevant user's perception of the attribute. Those data types may be selected based on historical assessment of the extent to which those attributes reflect that user's perception of the attribute.

In an exemplary embodiment, a computing device detects user interest in a phrase comprising one or more words. User interest may be detected by, for example, determining that the phrase has been highlighted by the user, by determining using a user-facing camera that the user has gazed at the phrase, or using other techniques. The phrase is mapped to at least one sensor type. The mapping may be based on a lexicon table that stores associations between phrases and sensor types. Sensor data is retrieved from at least one sensor of the mapped sensor type, and the retrieved sensor data is presented via a user interface.

In a further exemplary embodiment, information is received indicating user interest in an attribute. One or more data types is identified based on determined influences of the data types on user perception of the attribute. One or more data sources associated with the identified data types are identified. Data is obtained from the data sources based on information associated with the user interest. An analysis of the obtained data is generated based at least in part on the attribute, and the generated analysis is presented via a user interface.

In another exemplary embodiment, a computing device includes a communication interface, a processor; and a non-transitory data storage medium storing instructions executable by the processor for causing the computing device to carry out a set of functions, the set of functions comprising: (i) detecting user interest in a phrase comprising one or more words; (ii) mapping the phrase to one or more sensor types; (iii) retrieving sensor data from sensors of the mapped types; and (iv) presenting the retrieved sensor data via a user interface.

### BRIEF DESCRIPTION OF THE DRAWINGS

FIG. 1 depicts an architecture of a user agent, in accordance with an embodiment.

FIG. 2 depicts an architecture of a created service for places, in accordance with an embodiment.

FIG. 3 illustrates a functional architecture of a created service for places, in accordance with an embodiment.

FIG. 4 is a message flow diagram illustrating an exemplary exchange of information in an exemplary embodiment.

FIG. 5 depicts an architecture of a created service for physical objects, in accordance with an embodiment.

FIG. 6 depicts an architecture of a user agent for handling user-specific and composite aspects, in accordance with an embodiment.

FIG. 7 is a flow chart illustrating an exemplary method performed in some embodiments.

FIG. 8 depicts an architecture of a wireless transmit/receive unit (WTRU), in accordance with an embodiment.

### DETAILED DESCRIPTION

### User Agent

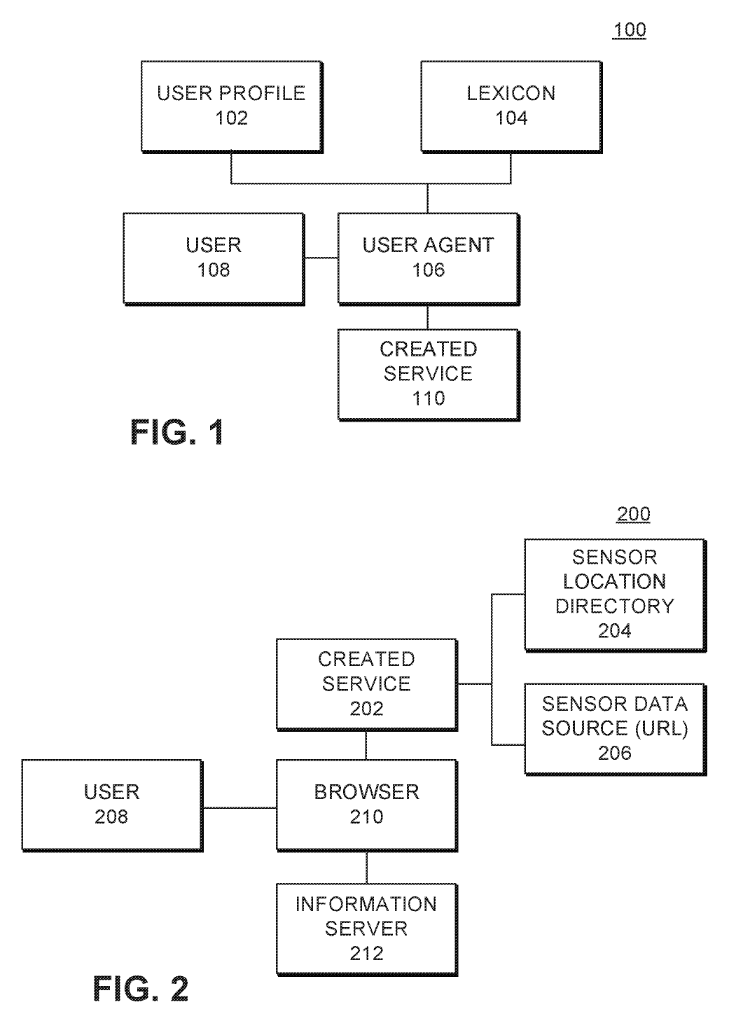

FIG. 1 depicts an architecture of a user agent, in accordance with an embodiment. In particular, FIG. 1 depicts the user agent architecture 100. The user agent architecture 100 includes a user profile 102, a lexicon 104, a user agent 106, a user 108, and a created service 110. The various components are communicatively coupled to transfer data and information.

The user agent 106 obtains information about the user's interest in some words or phrases—either by passively observing or being told, or informed, by the user 108. As an example, a user agent 106 detects that a user 108 has highlighted a given word or phrase. The given word or phrase could be part of a review, a news article, or other text, as examples. The text could be about a location or place—e.g., something having a fixed geocode and/or having some way to locate it in geographical space (such as hotel, a town square, etc.). As another example, the text could be about a media object—e.g., something with a fixed URL and/or some way to locate it in cyberspace. Additionally or alternatively, the text could be about a physical object—e.g., something that does not have a fixed geocode but has some identifier (such as a Vehicle Identification Number). The text could be about any combination of places, media objects, and/or physical objects, among other possibilities. A user 108 may highlight a word and/or phrase by using a mouse cursor (e.g., to click-and-drag and/or hover over the phrase) and/or by gazing at the word or phrase, as examples.

Places and physical objects may be equipped with various sensors. In some embodiments, for such places and physical objects, there are services that provide information about the sensors. For example, a vehicle's sensor data may be accessed through a service.

Respective sensors may be classified as one or more types. Upon detecting that the user 108 has highlighted one or more words, the user agent 106 maps the words to one or more types of sensors. For example, the word “hot” may map to a temperature sensor type (e.g., a thermometer). The word “leak” may map to a wetness sensor type (e.g., a rain gauge and/or a hygrometer). And the word “rattle” may map to a vibration sensor type (e.g., an accelerometer). The user agent 106 consults the Lexicon 104 that maps one or more words or phrases to respective sensor types. Of course, many other examples are possible as well. Such mappings may be manually specified (e.g., on a per-user basis) or determined automatically, among other possibilities that will be known to those of skill in the art.

Subsequent to mapping the highlighted words to one or more sensor types, the user agent 106 creates an end-user service 110 that retrieves information from sensors of those mapped types. The user agent 106 may generate a new service 110, for example, whenever the user 106 displays an interest in some sensor-relevant word or phrase (among other possibilities).

### Created Service

The created service 110 retrieves information about places or physical objects along with metadata from sensors of the mapped types, monitors sensor data as specified by the user agent 106 (e.g., in designated places, as described above), and provides relevant sensor data to the user agent 106. Whenever a description of a place or a physical object is to be displayed to the user 108, the created service 110 may insert a visualization of the sensor data (shown by time or spatial coordinates and summarized as appropriate, for example). The created service 110 may provide common-sense explanations for any one or more of the sensors to allow for easier interpretation the sensor data. The created service 110 may continue for a fixed period of time and/or until the service is manually terminated (e.g., by a user), among other possibilities. For example, up to a fixed number of the most-recently created services 110 may be kept alive and older services 110 may be retired. The priority of the created services 110 may be manually reordered by the user 108.

FIG. 2 depicts an architecture of a created service for places, in accordance with an embodiment. In particular, FIG. 2 depicts an architecture 200. The architecture 200 includes a created service 202, a sensor location directory 204, a sensor data source (URL) 206, a user 208, a browser 210, and an information server 212. Some components of the architecture 200 are similar to some components of the architecture 100. For example, the browser 210 may host the functions of the user agent 106, the created service 202 provides information to the browser 210 similarly as the created service 110 provides information to the user agent 106.

As depicted in FIG. 1, for places, the created service 202 consults a sensor location directory 204 that maintains available sensor data sources 206. The directory may be indexed by geocode (to help find sensor data associated with places). In an embodiment, for a place search, the created service 202 searches for matching sensors within a specified distance of the designated geocode. The user 200 may interact with the browser 210 to access an information server 212. The information server 212 may be the Internet, or other similar source of information.

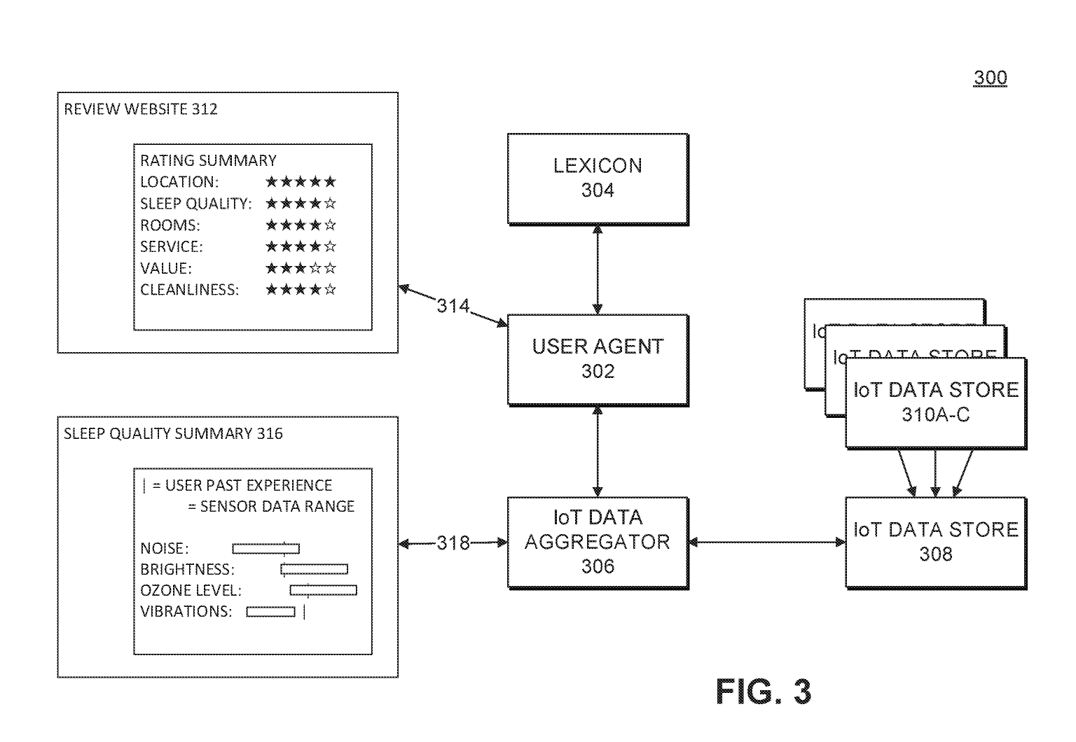

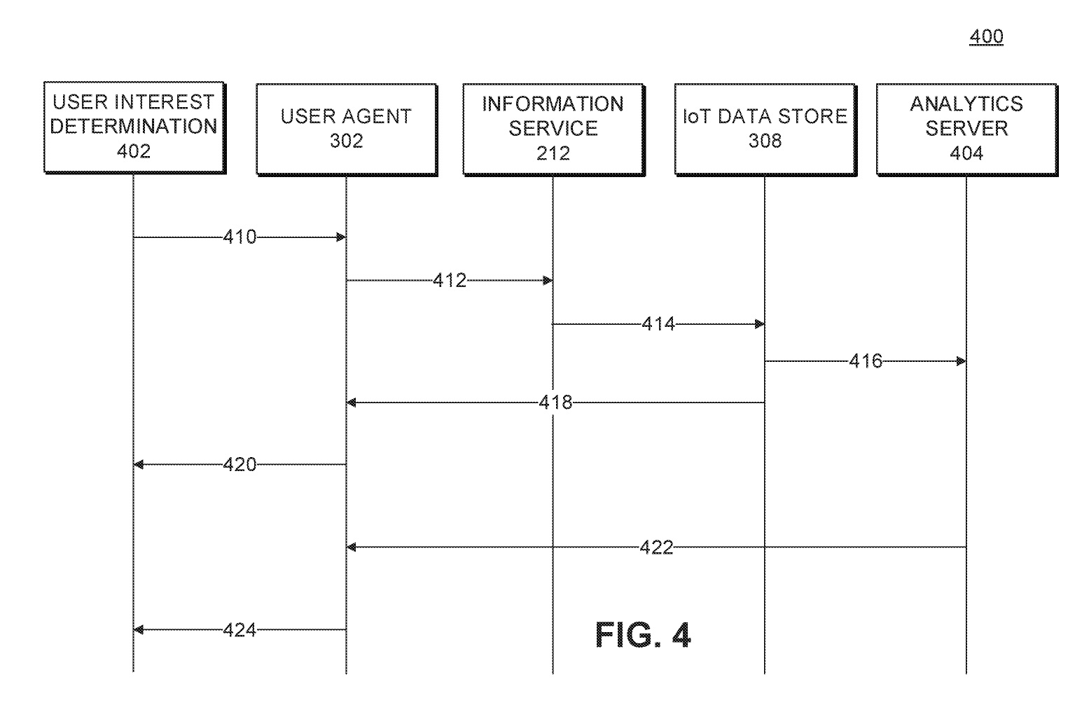

FIGS. 3 and 4 depict examples of a created service for places, in accordance with exemplary embodiments. FIG. 3 depicts an example 300. The example 300 includes a user agent 302, a lexicon 304, an Internet of Things (IoT) data aggregator 306, an IoT data store 308, data sources 310a-c, rating summary data 312, sleep quality data 314, a sleep quality summary for a location 316, and user interactions 318. FIG. 4 depicts the example 400. The example 400 includes some components from FIGS. 2-3, such as the information service 212, the user agent 302, and the IoT data store 308 and also includes a user interest determination 402, an analytics server 404, and process steps 410-424. The components depicted in FIGS. 3-4 may be configured to perform functions described with respect to other components described in the present disclosure. For example, the user agent 302 may act as the browser 210 (and interact with the created service 202), or as the user agent 106.

As an example, as illustrated in FIGS. 2 and 3, if the user has searched for a place (e.g., hotels in Istanbul or in Taksim Square), then the user agent 302 retrieves data from sensors of the selected types from the available instances of the place (such as all the hotels near Taksim Square, for example). Additionally or alternatively, the created service 202 may retrieve data from sensors (such as from sensors 310a-c through the IoT data store 308 and the IoT data aggregator 306) inside buildings (e.g., hotels). The created service 202 may retrieve the data from live sensors (e.g., from openly accessible sensors) in hotels. Whether live or stored, the sensor data originates from sensor readings in physical locations and not, e.g. from a review or opinion.

The sensors 310a-c may be any number of sensors, and in accordance with one embodiment, the sensor 310a is associated with sensors in a hotel, the sensor 310b is associated with city surveillance, and the sensor 310c is associated with mobile device sensors. The sensors 310a-c provide data to the IoT data store 308. In the embodiment where a user is reviewing hotel information relevant to sleep quality, the IoT data store 308 provides sensor data regarding noise, temperature, and light to the IoT data aggregator 306.

The types of sensors from which the user agent 302 obtains information may be limited by sensors that are relevant to the user's interests. Similar to the embodiment of FIG. 1, the user may interact with words associated with “sleep” or “sleep quality” and the user agent 302 consults a lexicon 304 to determine the types of sensors that can impact “sleep” or “sleep quality”. Each place may be associated with one or more sensors 310a-c. This association may be ownership or proximity. For example, the sensor may be near a hotel, it may be in the hotel and owned by the hotel, or it may be in the hotel and owned by a guest currently or previously present at that hotel. This association (and sensor type) is stored in a database that is maintained by the community of users or from sensor data aggregators. Techniques that may be used for the organization of sensor data include techniques described in, for example, J. Bers & M. Welsh, “CitySense: An Open Urban-scale Sensor Network Testbed” (slide presentation), Harvard University (2007); M. Foth et al. (eds.), Street Computing: Urban Informatics and City Interfaces. Abingdon, UK: Routledge (2014). ISBN 978-0-415-84336-2 (ebook); Foth, M. (ed.), Handbook of Research on Urban Informatics: The Practice and Promise of the Real-Time City (2009) Hershey, Pa.: Information Science Reference, IGI Global. ISBN 978-1-60566-152-0 (hardcopy), ISBN 978-1-60566-153-7 (ebook).

As depicted in FIG. 4, a user interest determination is made at 402. At step 410, the identified interest area is communicated to the user agent 302. The identified interest area may be based on semantic or lexicon based interests. The user agent 302 may be any tool service or user agent in communication with a semantic reasoner or lexicon. At step 412, a data request is sent to the information service 212. The data request contains specific data or service information. At step 414, a database query is sent to the IoT data store 308. The database query may involve querying user devices as well as referring to a stored database. At step 416, a data and analytics profile is sent to the analytics server 404. At step 418, IoT data store 308 returns raw data to the user agent 302, which returns user-relevant raw data to the user interest determination 402 at step 420. At step 422, the analytics server 404 returns analyzed data to the user agent 302, and user relevant analyzed data is forwarded to the user interest determination 402 at step 424.

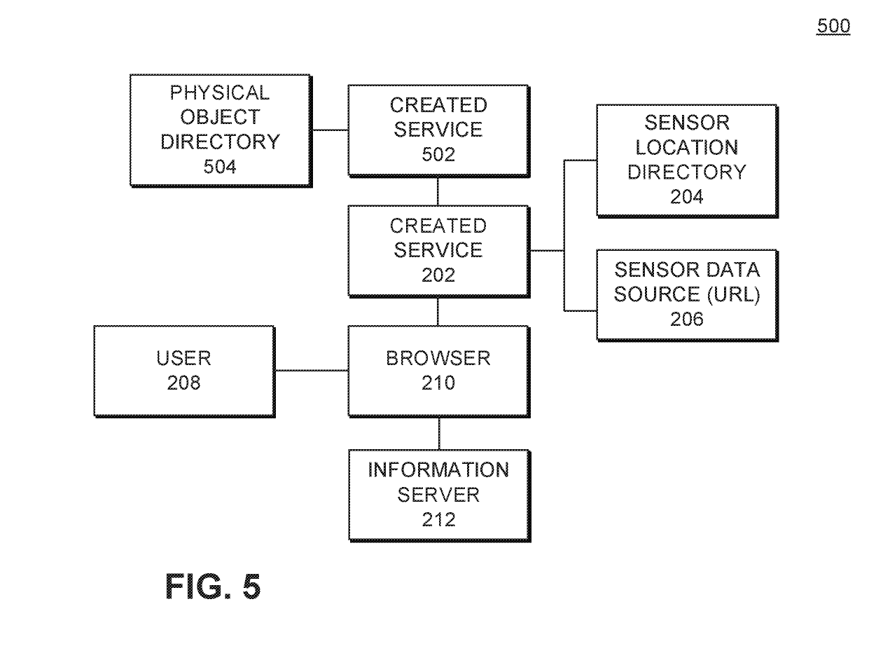

FIG. 5 depicts an architecture of a created service for physical objects, in accordance with an embodiment. In particular, FIG. 5 depicts the architecture 500. The architecture 500 includes many of the same items of FIG. 2, but also includes the created service 502 and a physical object directory 504.

As depicted in FIG. 4, for physical objects, the created service 502 consults the physical object directory 504 that maps object types to object instances (identifiers) and consults a sensor object directory 204 that maps object instance identifiers to sensors and their respective data source URLs 206. For example, if the user searches for a physical object (e.g., a car), the created services 502 find the different types of objects that answer to the user's query (e.g., different models of cars such as the 2015 Ford Mustang, 2015 Toyota Camry, etc.).

Having determined the types of objects, the created services 502 for physical objects find instances of those types of objects (e.g., one or more 2015 Ford Mustangs) and retrieves data of sensors (i) of the available instances that are (ii) of the mapped sensor types. The created service 502 may retrieve the data from live sensors (possibly accessible by the public) and/or via aggregators such as car dealers, manufacturers, hobbyist sites, etc. Whether live or stored, the sensor data originates from real-life physical objects (and not a review or opinion).

For media objects, the created service identifies physical objects or places referenced in the media objects (e.g., using known named-entity recognition techniques).

### Data Visualization

The user agent 302 may present the retrieved sensor data for examination (e.g., via a user interface). The user agent 302 may for example display statistics with respect to the sensor data, e.g., in a time-dependent way and/or in a spatial arrangement, among other possibilities. For example, the user agent 302 may display the statistics in a spatial arrangement with time variation, such as via a video. Places and objects can be grouped and selected based on the statistics. The user agent 302 may present live data streams from respective sensors (if such streams are available). The number of services displayed by the user agent may depend on the device size—e.g., fewer services may be shown on smaller devices and vice versa—and the sensor data itself may be organized spatially for display. The number of services presented may depend on the interaction modality (e.g., a single service for speech modality).

### Decision Tree

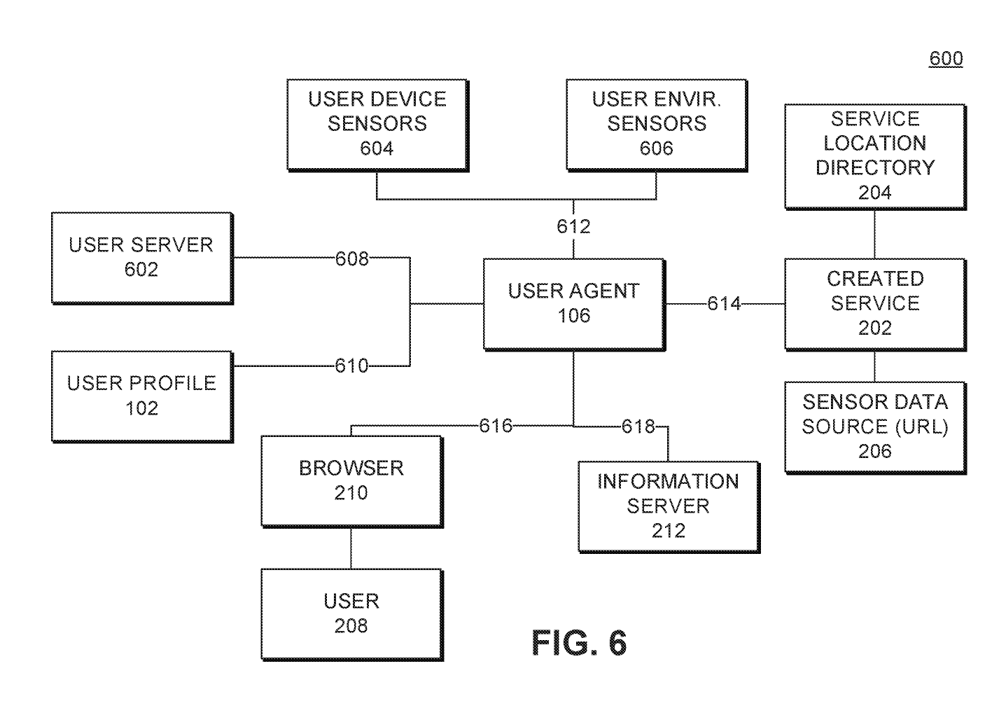

FIG. 6 depicts an architecture of a user agent for handling user-specific and composite aspects, in accordance with an embodiment. In particular, FIG. 6 depicts the architecture 600. The architecture 600 includes components from FIGS. 1-2, and also includes a user service 602, a sensor in a user's device 604, sensors in a user's environment 606, aspect information 608, decision trees 610, historical sensor data 612, live sensor data 614, predicted values 616, and place information 618.

In an embodiment illustrated in FIG. 5, to handle user-specific and composite aspects, a user agent 106 monitors sensors on a user's devices 604 and in the user's environment 606, and receives aspect information 608 (and optionally other information) from relevant user services 62. The user agent 106 maintains a user profile 102, including a decision tree 610 (or other decision tree) for each aspect that predicts specific values for that aspect based on sensor data and other information available from the user services 602.

The user agent 106 determines which aspect or aspects are most relevant to the user. When information 618 is obtained from an information server 212, the user agent 106 augments the obtained information with predicted values for the determined relevant aspects by applying previously constructed decision trees 610 to the sensor data retrieved via the created service 202. If an aspect has a small number of possible values (e.g., less than or equal to five), then the user agent 106 may differentiate them using distinct colors shown for the places retrieved from the information server 212. If an aspect has a larger number of possible values, then the user agent 106 may group the consecutive values so as to produce five groups.

As an example, if the user 208 expresses interest for a particular review aspect (such as sleep quality or healthy sleep) for which a user agent 106 has acquired information (e.g., from a sleep-quality or health app), the user agent 106 may store information on an ongoing basis about various sensor readings along with sleep-quality ratings produced automatically by an app or manually indicated by the user 208. The user agent 106 may build a decision tree 610 from these sensor readings (relating them to sleep quality rating) and when additional sensor data is obtained via the created service 202, the user agent 106 uses the decision tree 610 to predict sleep quality from the new data. For example, the user agent 106 may predict that sleep quality will be good for this user 208 because the noise-level (indicated by the sensor data) is medium and brightness is low—conditions that the user agent 106 may determine to be optimal for this user 208. Alternatively, the user agent 106 may predict poor sleep quality for the user 208 because the sensor data 612 indicates that there is too much car noise, for example.

### Place Example

The above architectures and examples may be used in an embodiment in which a user (Alice) uses her smartphone to search for hotels near Taksim Square in Istanbul. The smartphone displays a list of hotels near Taksim Square as well as community-provided comments regarding the respective hotels. One comment regarding a given hotel is that the hotel and the surrounding area were noisy. Alice is concerned about her husband's heart condition and wants to make sure he will be able to sleep well.

Table 1 depicts the results of a hotel search (various different display formats may be used).

TABLE 1

| Name | Geocode | Description | Reviews |
|---|---|---|---|
| Hilton | Lat1, | The best place in | Short walk to interesting |
| Taksim | Lon1 | Istanbul | places; noisy area |
| Sheraton | Lat2, | Site of historic student | Expensive; luxurious |
| Meydani | Lon2 | demonstrations | |

Alice interacts with the word “noisy” shown highlighted above, e.g. by gazing at the word or by selecting the word with a mouse. From this interaction, a user agent (executing on and/or accessible via the smartphone) determines that Alice is interested in “noisy” and employs the word as a basis for creating a new service for Alice.

Table 2 illustrates an example sensor lexicon that maps words and phrases to sensor types.

TABLE 2

| Word | Sensor Type |
|---|---|
| Noise | Sound |
| Loud | Sound |
| Quiet | Sound |
| Hot | Temperature |
| Cold | Temperature |
| Muggy | Temperature, Barometric |
| Humid | Moisture, Barometric |

The user agent selects sensor types based on Alice's interest in “noisy”. The user agent creates a service that finds noise-related sensors associated with any of the places that Alice considers.

Any service created by the user agent is based on a framework that provides access to a directory of sensor data (which could take the form of stored data or live data streams). For simplicity, each sensor data source is described herein as being accessible by a URL, and the formats of the query and data are established.

TABLE 3

| Sensor ID | Sensor Type | Sensor Location | Sensor Data Source URL |
|---|---|---|---|
| Istan1 | Sound | Lat1, Lon1 | www.example.com/tr/istanbul/taksim/s1 |
| Istan2 | Temperature | Lat1, Lon1 | www.example.com/tr/istanbul/taksim/t1 |
| Istan3 | Barometric | Lat2, Lon2 | www.example.com/tr/istanbul/taksim/b1 |
| Istan4 | Temperature | Lat2, Lon2 | www.example.com/tr/istanbul/taksim/t2 |
| Istan5 | Sound | Lat2, Lon2 | www.example.com/tr/istanbul/taksim/s2 |
| Istan6 | Sound | Lat3, Lon3 | www.example.com/tr/istanbul/taksim/s3 |

In the present example, some of the sensor data sources are live sensors provided by the hotels and/or by current guests of the hotels. Some sensor data is historical in that it has been stored from sensors of prior guests of the hotel and is being made available by an aggregator.

Whether Alice continues to look at the information about the current hotel or goes back and looks at the list of hotels she had opened before or looks for additional hotels (within the current “session”), the above-mentioned created service obtains the geocode for any new place whose description Alice views. The created service finds and retrieves appropriate sensor data sources relevant to that geocode. The user agent presents the retrieved noise-relevant sensor data for whatever hotels (or, more generally, whatever places) she considers.

The service created by the user agent provides all of the available sensor data in a summarized form (such as minimum, maximum, and average measurements for respective days). The service may also maintain and provide statistics for data retrieved during a given session (e.g., the noisiest and quietest places viewed in the last hour). Where appropriate, it can also provide live sensor streams in a real-time form.

By viewing the sensor data, Alice is able to make a decision as to which hotels are likely to have an ambient noise level that is generally well below her level of comfort. This acceptable noise level may be a constant value (such as a noise level below 70 or below 60 during her bedtime) or are relative level (such as a noise level in the lowest 30% of hotels).

### Physical Object Example

The above architectures and examples may be used in an embodiment in which a user (Carlos) is interested in buying or renting a car. While reading car reviews on his computer, he encounters a comment that some current Honda models experience excessive vibration. Carlos is concerned about vibration because he was bothered by vibration of a car he had in college. He re-reads the relevant sentences regarding excessive vibration and his eyes dwell on those sentences.

Carlos is considering the purchase of a Toyota Camry. A review search for Toyota Camrys does not help Carlos because reviewers of Toyota Camrys have not commented about vibration or have made comments about vibration of earlier models but not about the current year's models. Either Camrys have no vibration problems or typical Camry drivers do not care about vibration as much as Carlos and Honda drivers do. Carlos would benefit from more, objective data about Toyota Camrys (and other car models).

A user agent accessible via Carlos' computer creates a service for Carlos. Now when Carlos looks at the information for a car (such as a 2015 Toyota Camry), the service retrieves available sensor data from sensors in existing 2015 Toyota Camrys. The service does the same for 2015 Honda Accords when Carlos looks at that model. Carlos can then make a reasoned comparison based on the retrieved data.

The created service can enhance information on any type of physical object that is presented to Carlos (via the user agent) with information retrieved from sensors associated with instances of that object type. The created service may rely upon backend services that associate specific car instances with sensor data obtained from those specific instances.

### Media Object Example

The above architectures and examples may be used in an embodiment in which a user (Nancy) is looking at photos of places and/or physical objects on her tablet computer. A caption of one of the photos that includes the word “cold” catches Nancy's eye.

A user agent of the tablet identifies one or more places and physical objects from among the media objects that Nancy sees. For those places and physical objects, the user agent creates a service that obtains the relevant sensor data (in a manner similar to those of the previous examples) and presents to Nancy the data retrieved by the created service.

The user agent subsequently detects that Nancy is looking at a picture of Anchorage Harbor taken in June. In response, the user agent displays the current temperature readings form sensors in Anchorage Harbor, as well as a temperature time series for Anchorage Harbor. The user agent also displays temperature sensor data for places shown in other pictures that she sees, as well as temperature sensor data for places whose descriptions she reads. For example, Nancy later searches for hotels in Istanbul after becoming in temperature while looking at some pictures of Anchorage; the user agent accordingly presents to Nancy temperature data from the hotels in Istanbul (even though the user agent first detected her interest in temperate while she was looking at photos of Anchorage Harbor).

### User-Specific and Composite Aspect Example

The above architectures and examples may be used in an embodiment in which a user (Poyraz) is looking at reviews of hotels in Istanbul near Bogazici Universitesi. Poyraz is concerned about sleep quality based on his prior experiences in big-city hotels. His eyes dwell upon the sleep quality aspect of a hotel review page, and the user agent detects that Poyraz is interested in hotels in the Bogazici Universitesi area and is concerned about sleep quality.

The user agent has already built a user profile for Poyraz based on his sleep time and fitness tracker (e.g. Jawbone) applications. Using data from these applications, the user agent tracks his sleep quality every night. In addition, the user agent accesses sensors on Poyraz's personal devices (e.g., phones and wearables) and in his environment to determine the relevant sensor data (e.g., from noise, brightness, vibration, ozone, and temperature sensors). The user agent builds a decision tree model to predict Poyraz's sleep quality based on the sensor data available.

Using the above-mentioned decision tree model, the user agent obtains the sensor data provided by the created service, generates predictions for Poyraz's sleep quality for each place from which the sensor data is being retrieved, and presents the sensor data and generated predictions to Poyraz.

### Exemplary Method

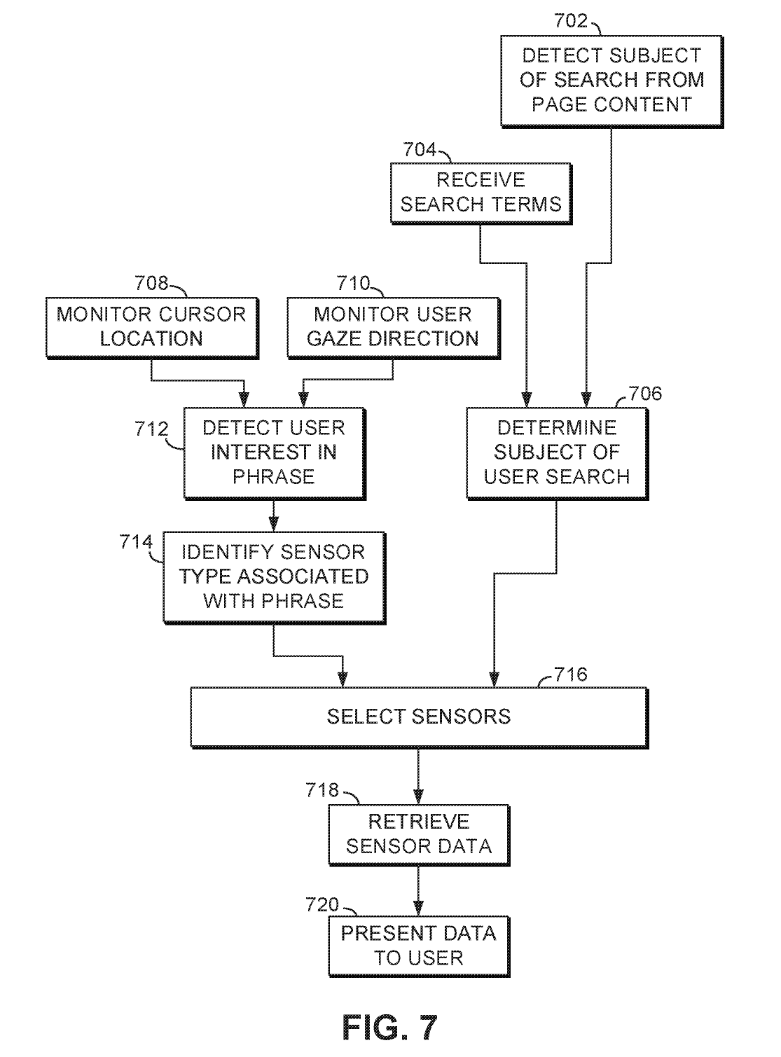

An exemplary method performed in some embodiments is illustrated in FIG. 7. In step 706, a computing system, such as a user device or a networked service, detects the subject of a user search. Determining the subject of the user search may be performed based explicitly on search terms entered by the user and received by the computing device (step 704). In some embodiments, the subject of the user's search is determined implicitly (step 702) from the content of a page being viewed by a user.

In step 712, the system detects user interest in a phrase in the search results. The phrase may be a single word or may be a multi-word phrase. In some embodiments, the system monitors a cursor location to determine when a user is hovering over a particular phrase (step 708). In some embodiments, the system includes a user-facing camera and monitors the user's gaze direction (step 710) to identify a phrase being gazed at by the user.

In step 714, the system identifies one or more types of sensors associated with the phrase of interest. An association between phrases and sensor types such as those given by way of example in Table 2 may be used to identify sensor types.

In step 716, the system selects appropriate sensors. The sensors selected may be sensors with the identified sensor type (or types) that are also associated with the subject of the user search. Sensors may be selected, for example, by querying a database of sensors. Where the subject of the user search is a location, the query may be limited to sensors that are in the location and/or have recently been in the location and still possess data regarding the location. Where the subject of the user search is a selected type of object, the query may be limited to sensors that are mounted in, on, or near a physical object of that selected type. In step 718, sensor data is retrieved from the selected sensors, and in step 720, the sensor data is presented to the user.

### Wireless Transmit/Receive Unit

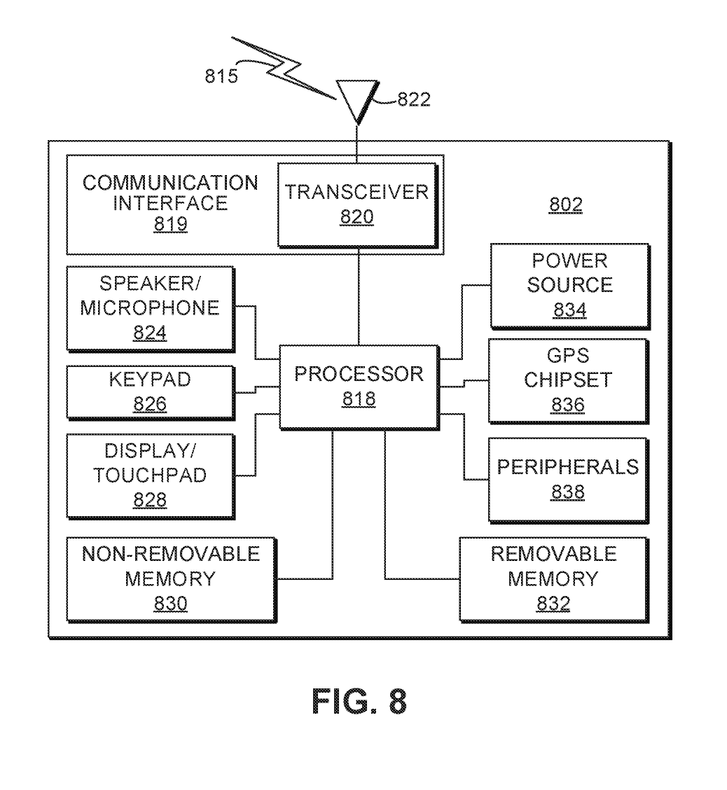

FIG. 8 depicts an architecture of a wireless transmit/receive unit (WTRU), in accordance with an embodiment. In particular, FIG. 8 depicts the WTRU 802.

Methods described herein may be performed by modules that carry out (i.e., perform, execute, and the like) various functions that are described herein. As used in this disclosure, a module includes hardware (e.g., one or more processors, one or more microprocessors, one or more microcontrollers, one or more microchips, one or more application-specific integrated circuits (ASICs), one or more field programmable gate arrays (FPGAs), one or more memory devices) deemed suitable by those of skill in the relevant art for a given implementation. Each described module may also include instructions executable for carrying out the one or more functions described as being carried out by the respective module, and it is noted that those instructions could take the form of or include hardware (i.e., hardwired) instructions, firmware instructions, software instructions, and/or the like, and may be stored in any suitable non-transitory computer-readable medium or media, such as commonly referred to as RAM, ROM, etc.

In some embodiments, the systems and methods described herein may be implemented in a wireless transmit receive unit (WTRU), such as WTRU 802 illustrated in FIG. 8. In some embodiments, the components of WTRU 802 may be implemented in a user agent, a created service, a device incorporating a user agent and/or created service, or any combination of these, as examples. As shown in FIG. 8, the WTRU 802 may include a processor 818, a communications interface 819 that includes a transceiver 820, a transmit/receive element 822, audio transducers 824 (preferably including at least two microphones and at least two speakers, which may be earphones), a keypad 826, a display/touchpad 828, a non-removable memory 830, a removable memory 832, a power source 834, a global positioning system (GPS) chipset 836, and other peripherals 838. It will be appreciated that the WTRU 802 may include any sub-combination of the foregoing elements while remaining consistent with an embodiment. The WTRU may communication to nodes such as, but not limited to, base transceiver station (BTS), a Node-B, a site controller, an access point (AP), a home node-B, an evolved home node-B (eNodeB), a home evolved node-B (HeNB), a home evolved node-B gateway, and proxy nodes, among others.

The processor 818 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. The processor 818 may perform signal coding, data processing, power control, input/output processing, and/or any other functionality that enables the WTRU 802 to operate in a wireless environment. The processor 818 may be coupled to the transceiver 820, which may be coupled to the transmit/receive element 822. While FIG. 8 depicts the processor 818 and the transceiver 820 as separate components, it will be appreciated that the processor 818 and the transceiver 820 may be integrated together in an electronic package or chip.

The transmit/receive element 822 may be configured to transmit signals to, or receive signals from, a node over the air interface 815. For example, in one embodiment, the transmit/receive element 822 may be an antenna configured to transmit and/or receive RF signals. In another embodiment, the transmit/receive element 822 may be an emitter/detector configured to transmit and/or receive IR, UV, or visible light signals, as examples. In yet another embodiment, the transmit/receive element 822 may be configured to transmit and receive both RF and light signals. It will be appreciated that the transmit/receive element 822 may be configured to transmit and/or receive any combination of wireless signals.

In addition, although the transmit/receive element 822 is depicted in FIG. 8 as a single element, the WTRU 802 may include any number of transmit/receive elements 822. More specifically, the WTRU 802 may employ MIMO technology. Thus, in one embodiment, the WTRU 802 may include two or more transmit/receive elements 822 (e.g., multiple antennas) for transmitting and receiving wireless signals over the air interface 815.

The transceiver 820 may be configured to modulate the signals that are to be transmitted by the transmit/receive element 822 and to demodulate the signals that are received by the transmit/receive element 822. As noted above, the WTRU 802 may have multi-mode capabilities. Thus, the transceiver 820 may include multiple transceivers for enabling the WTRU 802 to communicate via multiple RATs, such as UTRA and IEEE 802.11, as examples.

The processor 818 of the WTRU 802 may be coupled to, and may receive user input data from, the audio transducers 824, the keypad 826, and/or the display/touchpad 828 (e.g., a liquid crystal display (LCD) display unit or organic light-emitting diode (OLED) display unit). The processor 818 may also output user data to the speaker/microphone 824, the keypad 826, and/or the display/touchpad 828. In addition, the processor 818 may access information from, and store data in, any type of suitable memory, such as the non-removable memory 830 and/or the removable memory 832. The non-removable memory 830 may include random-access memory (RAM), read-only memory (ROM), a hard disk, or any other type of memory storage device. The removable memory 832 may include a subscriber identity module (SIM) card, a memory stick, a secure digital (SD) memory card, and the like. In other embodiments, the processor 818 may access information from, and store data in, memory that is not physically located on the WTRU 802, such as on a server or a home computer (not shown).

The processor 818 may receive power from the power source 834, and may be configured to distribute and/or control the power to the other components in the WTRU 802. The power source 834 may be any suitable device for powering the WTRU 802. As examples, the power source 834 may include one or more dry cell batteries (e.g., nickel-cadmium (NiCd), nickel-zinc (NiZn), nickel metal hydride (NiMH), lithium-ion (Li-ion), and the like), solar cells, fuel cells, and the like.

The processor 818 may also be coupled to the GPS chipset 836, which may be configured to provide location information (e.g., longitude and latitude) regarding the current location of the WTRU 802. In addition to, or in lieu of, the information from the GPS chipset 836, the WTRU 802 may receive location information over the air interface 815 from a base station and/or determine its location based on the timing of the signals being received from two or more nearby base stations. It will be appreciated that the WTRU 802 may acquire location information by way of any suitable location-determination method while remaining consistent with an embodiment.

The processor 818 may further be coupled to other peripherals 838, which may include one or more software and/or hardware modules that provide additional features, functionality and/or wired or wireless connectivity, including sensor functionality. For example, the peripherals 838 may include an accelerometer, an e-compass, a satellite transceiver, a digital camera (for photographs or video), a universal serial bus (USB) port, a vibration device, a television transceiver, a hands free headset, a Bluetooth® module, a frequency modulated (FM) radio unit, a digital music player, a media player, a video game player module, an Internet browser, and the like.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

1. A method comprising:
determining a subject of a user search;
displaying results of the user search;
detecting that a user has highlighted a phrase displayed in the search results;
in response to the detection of the highlighting of the phrase, automatically (i) identifying at least one sensor type associated with the highlighted phrase, (ii) retrieving sensor data from at least one sensor that has the identified sensor type and that is associated with the subject of the user search, and (iii) presenting the retrieved sensor data to the user.

2.-4. (canceled)

5. The method of claim 1, wherein identifying at least one sensor type associated with the phrase includes locating the phrase in a lexicon table, where the lexicon table maps phrases to sensor types.

6. The method of claim 1, wherein the subject of the user search is a place, and wherein a sensor associated with the place includes a sensor in proximity to the place.

7. The method of claim 1, wherein the subject of the user search is a selected type of object, and wherein a sensor associated with the type of object includes a sensor provided at a physical object of the selected type.

8. The method of claim 1, wherein presenting the data includes presenting an attribute predicted based on the data.

9. The method of claim 8, wherein the attribute is further predicted based on a user history.

10. A method comprising:
receiving, from a user device, information identifying a subject of a user search;
receiving, from the user device, an indication that a user highlighted a phrase included in the search results;
in response to the indication of the highlighting, automatically (i) identifying at least one sensor type associated with the highlighted phrase, (ii) retrieving sensor data from at least one sensor of the identified sensor type that is associated with the subject of the user search, and (iii) sending the retrieved sensor data to the user device.

11.-14. (canceled)

14. The method of claim 10, wherein identifying at least one sensor type associated with the phrase includes locating the phrase in a lexicon table, where the lexicon table maps phrases to sensor types.

15. The method of claim 10, wherein the subject of the user search is a place, and wherein a sensor associated with the place includes a sensor in proximity to the place.

16. The method of claim 10, wherein the subject of the user search is a selected type of object, and wherein a sensor associated with the type of object includes a sensor provided at a physical object of the selected type.

17. The method of claim 10, wherein presenting the data includes presenting an attribute predicted based on the data.

18. The method of claim 17, wherein the attribute is further predicted based on a user history.

19. A user device comprising a user-facing camera, a user interface, a processor, and non-transitory computer data storage medium storing instructions operative, when executed on the processor to perform functions comprising:
determining a subject of a user search;
displaying results of the user search on the user interface;
detecting, by the user-facing camera, the user gazing at a phrase displayed in the search results;
in response to the detection of user interest, automatically (i) identifying at least one sensor type associated with the gazed-at phrase, (ii) retrieving sensor data from at least one sensor that has the identified sensor type and that is associated with the subject of the user search, and (iii) presenting the retrieved sensor data to the user on the user interface.

20. (canceled)
